(19) United States
(12) Patent Application Publication
(10) Pub. No.: US 2007/0200647 A1
(43) Pub. Date: Aug. 30, 2007

(54) Method of manufacturing spherical or hemispherical crystal blank and method of manufacturing spherical saw device

(76) Inventors: Mitsuaki Koyama, Sayama-shi (JP); Yukihiro Kobayashi, Sayama-shi (JP)

Correspondence Address: JORDAN AND HAMBURG LLP, 122 EAST 42ND STREET, SUITE 4000, NEW YORK, NY, 10168, US

(21) Appl. No.: 11/704,125

(22) Filed: Feb. 8, 2007

(30) Foreign Application Priority Data
Feb. 9, 2006 (JP) 2006-32387

(51) Int. Cl. G03H 1/26

(52) U.S. Cl. 333/129; 359/22; 29/25.35; 333/133

(57) ABSTRACT

A method of manufacturing a spherical crystal blank in which the crystal axis is determined by a simple work with a high degree of accuracy includes the steps of: cutting out a cube from a crystal blank provided with crystal axes including a Z axis, and X and Y axes orthogonal to the Z axis, the cube including the Z axis as a side and being of a size capable of including the spherical crystal blank to be manufactured; then forming a reference hole for Z axis extending along the Z axis direction in reference to the side of the cube in the cube; and thereafter, forming the cube into a sphere so as to include a portion of the reference hole for Z axis.

### BACKGROUND OF THE INVENTION

1. Field of the Invention

The present invention relates to a method of manufacturing a spherical or a hemispherical crystal blank, applied to a piezoelectric resonator which is used for a piezoelectric device equipped in an electric device such as a spherical SAW device, or applied to a spherical lens or the like used for a digital still camera.

2. Description of the Related Art

The SAW device which is a kind of piezoelectric devices is an element applying a surface acoustic wave (SAW) transmitted on the surface of an elastic body. Elastic vibration transmitted on the surface of a crystal substrate has a small propagation velocity compared with an electromagnetic wave by as small as one hundred-thousandth, which makes it possible to compose a small-sized filter or a delay element. Therefore, it is widely used in TV receivers, cell phones, or communications equipment. Among them, the spherical SAW device used for gas sensors or the like is structured, for instance, in a manner that an interdigital transducer (IDT) 12 is disposed on the surface of a spherical piezoelectric crystal blank 11 arranged on a substrate 10, the spherical piezoelectric crystal blank 11 being such as quartz, LiNbO₃ (lithium niobate), LiTaO₃ (lithium tantalate) or the like, and electromechanical mutual conversion between an electric signal and a surface acoustic wave is conducted to make it carry frequency selection (band filter) characteristics as shown in FIG. 10.

Incidentally, the crystal blank such as the above-described quartz or the like is provided with three crystal axes, a Z axis (optical axis), and X and Y axes which are orthogonal to the Z axis. Since the surface acoustic wave (SAW) propagates along the above-described X axis, in order to install the IDT electrode 12 on the surface of the spherical body 11 along the direction of propagation of the surface acoustic wave, which is determined in advance, and to make the substrate 10 support the spherical body 11 in a prescribed positional relation, it is necessary to find the optical axis of the spherical body 11 before installing the IDT electrode 12 on the spherical body 11.

Conventionally, the optical axis of the spherical body 11 is examined using a polarized light after forming the spherical body 11 from a crystal blank such as quartz or the like first. Specifically, the method of detecting the optical axis is used by irradiating light from the underside of the spherical body 11 to find a point where no light transmitted through while rotating the spherical body 11.

However, the size of the spherical SAW device used for a gas sensor is, for instance, about 15 mm in diameter, and a method to check a polarized light while rotating the small spherical body 11 requires time and labor for the detection work, and errors are likely to arise. Recently, in order to widen the versatility in usage such as installing the spherical SAW device in a small pipe, further miniaturization of the spherical body 11 becomes necessary, which incurs further difficulty in performing the work.

When the detection of an optical axis is difficult as above, manufacture of the spherical SAW device also requires time and labor as a result, which incurs increase of manufacturing costs. Furthermore, when the crystal axis of the spherical SAW device varies, the variation of a reflection coefficient or the like becomes large, or variation appears in the number of orbitings or in response of signals when the surface acoustic wave of the spherical SAW device orbits around the surface of the spherical body 11 along the X axis, which results in unevenness of the characteristics of the product.

The spherical lens which is an optical device of a digital still camera is composed of a crystal blank such as quartz or the like, and even in this case, accurate determination of the optical axis direction is required to prevent occurrence of a moiré. However, prior-art documents on the spherical SAW devices have been searched in vain, and it can be said that any specific method of determining the optical axis with a highly accurate technique has not established yet.

### SUMMARY OF THE INVENTION

The present invention has been made in consideration of these circumstances, and its object is to provide a technology capable of reducing the manufacturing costs of a spherical or a hemispherical crystal blank by determining its crystal axis with a simple work with a high degree of accuracy, when the spherical or hemispherical crystal blank is manufactured. Another object of the present invention is to provide a technology capable of reducing variation of light energy, when applying the spherical or hemispherical crystal blank as a spherical SAW device. Still another object is to provide a technology capable of preventing occurrence of a moiré, when applying the spherical or hemispherical crystal blank as a spherical lens or a convex lens.

For this purpose, a method of manufacturing a spherical or a hemispherical crystal blank provided with crystal axes including a Z axis, and X and Y axes which are orthogonal to the Z axis includes the steps of:

cutting out a polyhedron, having a side extending in any one of crystal axis directions among the Z, X, and Y axis directions, and being of a size capable of including the spherical or hemispherical body to be manufactured;

forming a reference hole for crystal axis extending along the direction of the above-described crystal axis in the above-described polyhedron, in reference to the one side extending in the crystal axis direction of the above-described polyhedron; and

forming the above-described polyhedron into a spherical shape or a hemispherical shape so as to include the whole or a portion of the above-described reference hole for crystal axis.

The reference hole for crystal axis extending along the above-described crystal axis direction includes one extending in a prescribed direction with respect to the crystal axis direction as well as one extending in the direction the same as the crystal axis direction.

A piezoelectric resonator, a spherical lens, or a convex lens can be cited as an example of the spherical or hemispherical crystal blank. These crystal bodies are formed of any of, for instance, quartz, lithium niobate, or lithium tantalate. It is preferable that the diameter of the reference hole for crystal axis is adjusted to be 0.1% to 5% with respect to the diameter of the spherical or the hemispherical crystal blank.

A method of manufacturing the spherical SAW device according to the present invention includes installing an IDT electrode in parallel to the above described X axis in reference to the above-described reference hole for crystal axis to a spherical crystal blank manufactured by conducting the steps of: cutting a polyhedron having one side extending in the crystal axis direction of any one of the Z, X, and Y axes, and being of a size to include the spherical crystal blank to be manufactured; forming a reference hole for crystal axis extending along the above-described crystal axis direction in the above-described polyhedron; and thereafter, forming the above-described crystal blank in a spherical shape so as to include the whole or a portion of the above-described reference hole for crystal axis.

According to the present invention, when manufacturing a spherical or a hemispherical crystal blank provided with crystal axes including the Z axis, the X axis, and the Y axis, since a reference hole for crystal axis extending along the above-described crystal axis direction is formed to a polyhedron having one side extending in the crystal axis direction of any one out of the Z axis, the X axis and the Y axis, in reference to the above-described one side, it is possible to determine the crystal axis with a simple work with a high degree of accuracy. Furthermore, since the spherical or the hemispherical crystal blank is manufactured by forming a polyhedron provided with the above-described reference hole for crystal axis into a spherical shape or a hemispherical shape, little labor or time is required for the manufacturing work, so that its manufacturing costs can be reduced.

When the spherical crystal blank is used as a piezoelectric resonator of a spherical SAW device, since an IDT electrode is installed parallel to the X axis in reference to a highly accurate crystal axis, the positional accuracy of the IDT electrode is also high, which makes it possible to reduce the variation of light energy. In addition, when this spherical or hemispherical crystal blank is used as a spherical lens or a convex lens, it is possible to prevent occurrence of a moire.

### BRIEF DESCRIPTION OF THE DRAWINGS

FIG. 1 is a perspective view showing an example of a synthetic quarts crystal blank used in the present invention;

FIGS. 2A and 2B are perspective views showing manufacturing processes of the spherical SAW device of the present invention;

FIG. 3 is a perspective view showing a manufacturing process of the spherical SAW device of the present invention;

FIGS. 4A and 4B are side views showing other examples of the spherical crystal blank of the present invention;

FIGS. 5A and 5B are perspective views showing manufacturing processes of the spherical SAW device of the present invention;

FIG. 6 is a side view showing still another example of the spherical crystal blank of the present invention;

FIG. 7 is a side view showing yet another example of the spherical crystal blank of the present invention;

FIG. 8 is a characteristic graph showing the result of an embodiment conducted to confirm the effect of the method according to the present invention;

FIG. 9 is a characteristic graph showing the result of a comparison example conducted to confirm the effect of the method according to the present invention; and

FIG. 10 is a side view to explain the spherical SAW device.

### DETAILED DESCRIPTION OF THE PREFERRED EMBODIMENT(S)

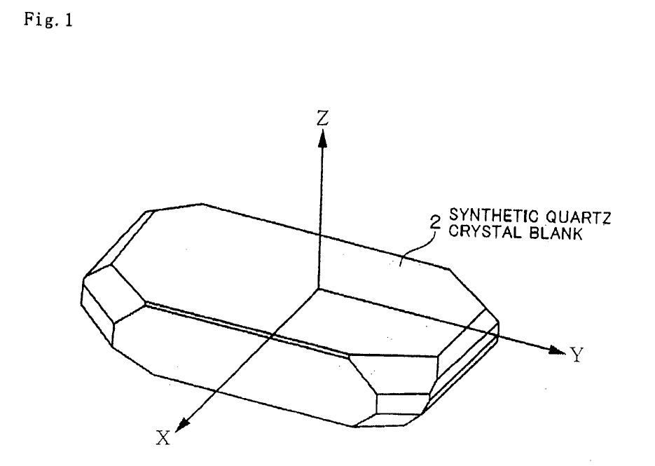

An embodiment of the present invention will be explained using the case of forming a spherical SAW device as an example. FIG. 1 is a schematic diagram showing a synthetic quartz crystal blank 2 as an example of the crystal blank provided with crystal axes including a Z axis (optical axis), and X and Y axes which are two axes orthogonal to the Z axis. Here, as the crystal blank provided with crystal axes including a Z axis, an X axis, and a Y axis, the crystal blank of a piezoelectric crystal with a polarizing function such as LiNbO3, LiTaO3, or the like as well as quartz can be used.

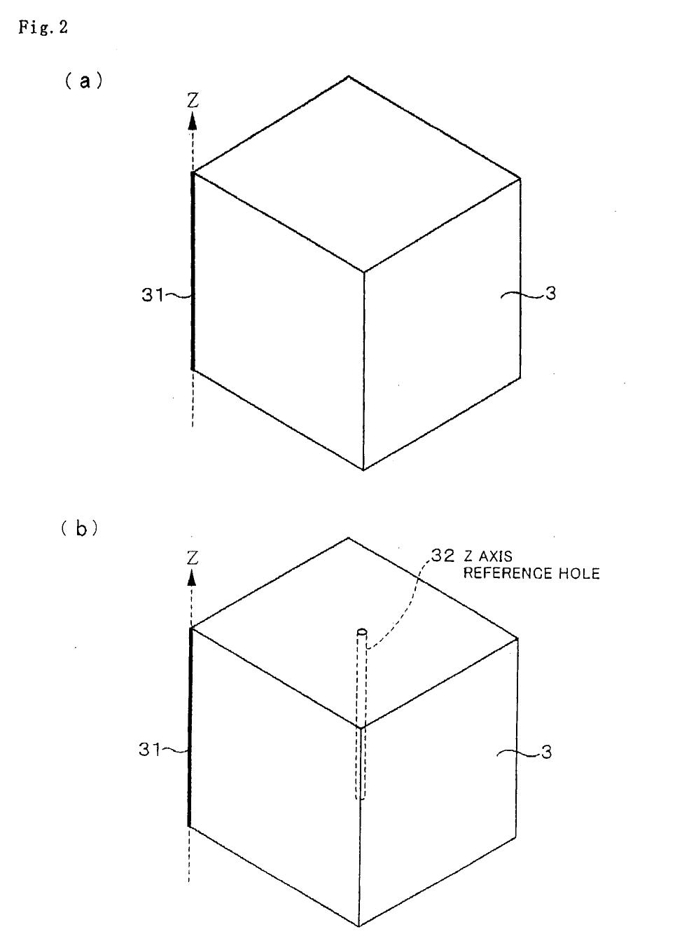

First, as shown in FIG. 2A, a polyhedron, whose one side 31 extends along the above-described Z direction, for instance, a cube 3, is cut out from the above-described quartz crystal blank 2. At this time, when one having 10 m in diameter is to be formed as a spherical crystal blank to be used for the spherical SAW device (piezoelectric resonator), a side of the cube 3 is determined to be 15 mm in length. A process of cutting out the cube 3 from the quartz crystal blank 2 is conducted with, for instance, a wire saw. At this time, the position of the above-described Z axis direction is detected with a high degree of accuracy by means of, for instance, X-rays, and the cube 3 is cut out in a state that one side 31 of the cube 3 is parallel to the z axis direction. It should be noted that the shape of the polyhedron is not limited to the above-described cube, provided that it has a side extending along the Z axis direction, and is of a size capable of including the spherical crystal blank to be formed.

Next, as shown in FIG. 2B, a reference hole for Z axis (reference hole for crystal axis) 32, which extends along the above-described Z axis direction, in reference to the side 31 extending in the Z axis direction, is formed to the cube 3. The reference hole for Z axis 32 has a diameter significantly shorter than the diameter of the spherical crystal blank used as the spherical SAW device. The process of forming the reference hole for Z axis 32 is conducted by, for instance, an ultrasonic processing machine. Here, for simple processing, the hole diameter of the above-described reference hole for Z axis 32 is determined to be about 0.1% to about 5% of the diameter of the above described spherical crystal blank, and since the diameter of the above described spherical crystal blank is 10 mm, the length is determined to be, for instance, about 9.8 mm, which is shorter than the above-described diameter.

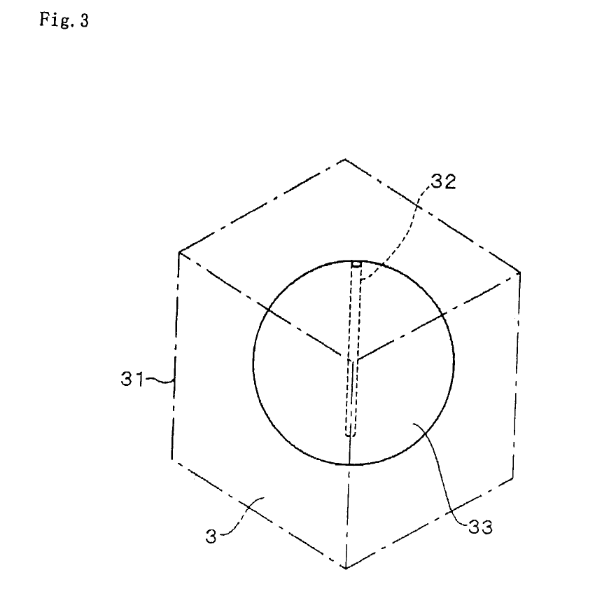

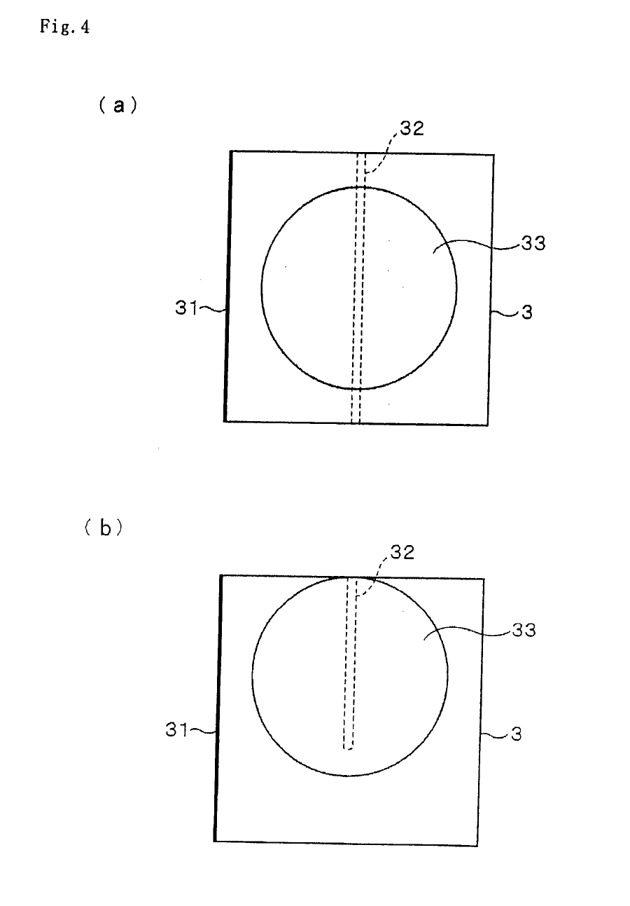

Next, as shown in FIG. 3, a spherical crystal blank (piezoelectric resonator) 33 having a diameter of 10 mm is formed in a manner to include the above-described reference hole for Z axis 32. The process to form the spherical crystal blank 33 is performed, for instance, by polishing or using abrasives. Thus, formed is a spherical piezoelectric resonator whose Z axis direction is clearly indicated by the reference hole for Z axis 32. Here, the piezoelectric resonator 33 may form to include a portion of the reference hole for Z axis 32, and thus as shown in FIG. 4A, it may be configured that the reference hole for Z axis 32 pierces the piezoelectric resonator 33, or as shown in FIG. 4B, it may be configured that the reference hole for Z axis 32 does not pierce the piezoelectric resonator 33 by forming the piezoelectric resonator to include the whole of the reference hole for Z axis 32. However, in the case of transmitting an acoustic wave on the surface of the piezoelectric resonator 33 as in the case of a spherical SAW device, it is preferable to form the reference hole for Z axis 32 so as not to pierce the piezoelectric resonator 33 to prevent from giving an influence on the transmission.

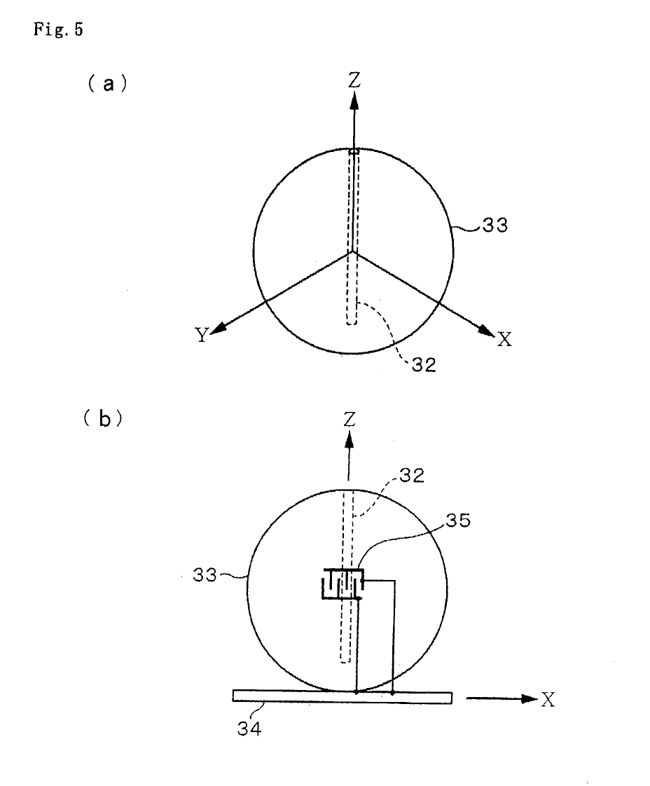

Then, as shown in FIG. 5A, in reference to the Z direction indicated by the above-described reference hole for Z axis 32, an X axis or a Y axis orthogonal to the Z axis is detected, and thereafter as shown in FIG. 5B, the piezoelectric resonator 33 is attached to a substrate 34 in reference to the above-described reference hole 32 for Z axis, the X axis or the Y axis. In this example, the piezoelectric resonator 33 is attached in a manner that the substrate 34 is parallel to the above-described X axis direction. Furthermore, an DDT electrode 35 is installed on the surface of the piezoelectric resonator 33 so that their electrode fingers are arranged along the detected X axis, and thus a spherical SAW device is formed. “The electrode fingers of the IDT electrode are arranged along the X axis” means that in the equator of the spherical crystal blank 3 assuming that the Z axis is the earth's axis, the IDT electrode 35 is arranged near a tangent extending in the X axis direction. Accordingly, the IDT electrode 35 is provided, for instance, in a manner that the center of the electrode finger group is positioned at the contact point of the equator and the tangent.

As to the above, the present invention is achieved by paying attention to the fact that when a polyhedron is cut out from the quartz crystal blank 2, conventionally, the polyhedron has been cut out in a manner that the side 31 is aligned so as to extend along the crystal axis direction (Z axis direction in this example) when the polyhedron is cut out from the quartz crystal blank 2. Since the reference hole for Z axis 32 is formed in the polyhedron in reference to the above-described side 31, the reference hole for Z axis 32 can be formed easily and with high positional accuracy. That is, the above-described side 31 is cut out from the crystal blank 2 in a state that it is accurately aligned in the Z axis direction in this example, and since it is enough for the reference hole for Z axis 32 to be formed so as to maintain the positional relation parallel to the side 31 in the polyhedron in reference to the side 31, it can be easily formed. Furthermore, since the positional accuracy of the side 31 is high as a criterion, the reference hole for Z axis 32 is formed in a state of being precisely aligned.

Accordingly, it is possible to form the reference hole for Z axis 32 to be a mark indicating the Z axis direction in the above-described spherical crystal blank 33 with a significantly simple way and with a high degree of accuracy, by forming the reference hole for Z axis 32 parallel to the side 31 of the cube 3 in reference to the side 31, and then forming the spherical crystal blank 33 so as to include the reference hole for Z axis 32. When the spherical crystal blank (piezoelectric resonator) 33 prepared according to the above-described method is used as a piezoelectric resonator of the spherical SAW device, since the mark indicating the Z axis direction is formed in advance on the above-described piezoelectric resonator 33, attachment to the substrate 34 or installation of the IDT electrode 35 can be performed in reference to the reference hole for Z axis 32, which makes it easy to manufacture spherical SAW devices. Therefore, it does not require time and labor for the manufacturing work, which makes it possible to reduce the manufacturing costs.

In addition, since the positional accuracy of the above-described reference hole for Z axis 32 in indicating the direction of the Z axis, a high degree of the positional accuracy at the time of installing the IDT electrode 35 to be arranged in parallel to the X axis can be obtained. Since the above-described surface acoustic wave propagates the surface of the piezoelectric resonator 33 along the X axis, by arranging the IDT electrode 35 in parallel to the X axis with highly accurate positional relation, it becomes possible to efficiently propagate the surface acoustic wave. Thereby, the variation of light energy is reduced, which makes it possible to reduce energy loss.

As to the above, the method of manufacturing according to the present invention can be applied not only to a spherical crystal blank, but also to a hemispherical crystal blank, and the hemispherical crystal blank includes one formed by being cut down along a diameter, and also one cut down at a position deviated from the diameter. Furthermore, the present invention can be applied to manufacture of a spherical lens or a convex lens which is an optical device of, for instance, a digital still camera. When manufacturing the spherical lens or the convex lens, a spherical crystal blank (spherical lens) or a hemispherical lens is formed in a size of, for instance, about 5.0 mm in diameter by the same method as in the spherical crystal blank 33 of the aforementioned spherical SAW device, and the reference hole for Z axis is formed in a hole diameter of 0.1 mm and the length of about 0.1 mm. Note that as for the SAW device, the method of manufacturing it according to the present invention can be applied not only to a spherical SAW device, but also to a hemispherical SAW device.

In this case, since the mark indicating the Z axis direction is formed in advance on the spherical lens or the concave lens, installation of the spherical lens or the concave lens on a substrate can be performed in reference to the reference hole for Z axis, which reduces time and labor for manufacturing and installation work of the spherical lens so that it is possible to reduce the manufacturing costs.

In addition, since the positional accuracy of the above-described reference hole for Z axis in indicating the Z axis direction is high, the positional accuracy at the time of installing a spherical lens or a convex lens to the electrode becomes high. Accordingly, alignment in the Z axis direction (optical direction) can be conducted accurately so that occurrence of a moire can be restrained.

### Embodiment

An experimental example conducted to confirm the method of the present invention will be explained hereinafter.

### Embodiment 1

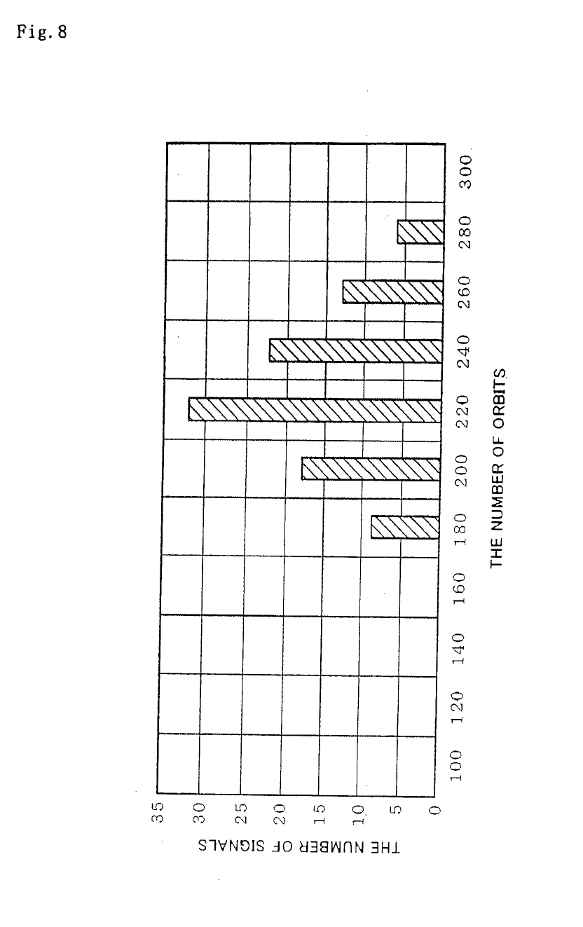

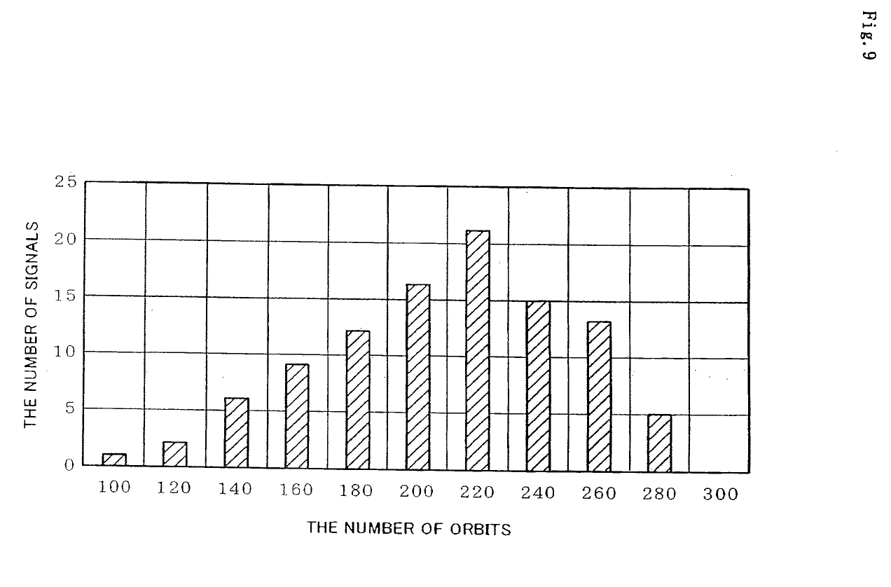

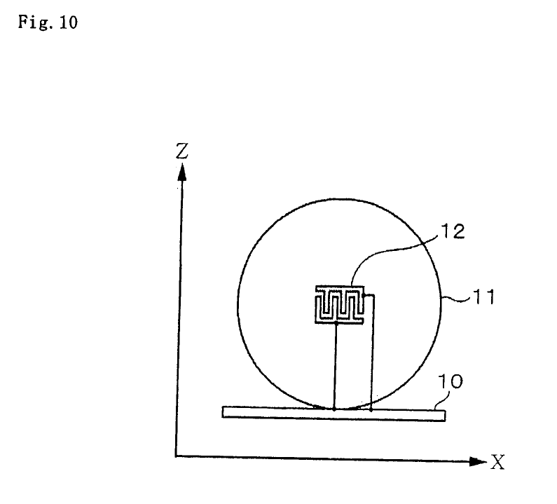

A spherical piezoelectric resonator of 10 mm in diameter was formed according to the above-described method. At this time, a cube with a side 15 millimeter long was formed as a polyhedron, and the reference hole for Z axis 32 was formed to have a hole of 0.2 mm in diameter and 0.1 mm in length, so that the reference hole for Z axis 32 did not pierce the spherical piezoelectric resonator 33. A spherical SAW device was formed by installing the IDT electrode 35 to this piezoelectric resonator 33 in reference to the reference hole for Z axis 32, and the number of orbitings that a signal having a frequency of 400 kHz goes round the surface of the piezoelectric resonator 33 was counted. The result is shown in FIG. 8. In the figure, the vertical axis indicates the number of signals and the horizontal axis indicates the number of the orbits of the above-described signal, respectively. In other words, the figure indicates the number of the signals which orbit around the surface of the piezoelectric resonator 33 n times in a certain lot. It means that the smaller the number of orbitings, the better the data, showing more uniform distribution,

### COMPARISON EXAMPLE 1

After forming the spherical piezoelectric resonator with of a size 10 mm in diameter was formed, the Z axis (optical axis) of the piezoelectric resonator was determined by means of using the polarized light as described in a paragraph “Description of the Related Art”. The IDT electrode was installed in reference to this Z axis and a spherical SAW device was formed to conduct the similar experiment to that in embodiment 1. The result is shown in FIG. 9.

(Consideration)

From these experimental results, in the spherical SAW device formed by the method according to the present invention, the distribution of the number of orbitings is more uniform compared with the spherical SAW device formed by a conventional method, and it was confirmed that the degree of variation became significantly small. From this result, by the method according to the present invention, the positional accuracy of the Z axis is high, which makes it possible to install the IDT electrode to the piezoelectric resonator with significantly high positional accuracy, so that it can be understood that the light energy loss of the spherical SAW device can be reduced.

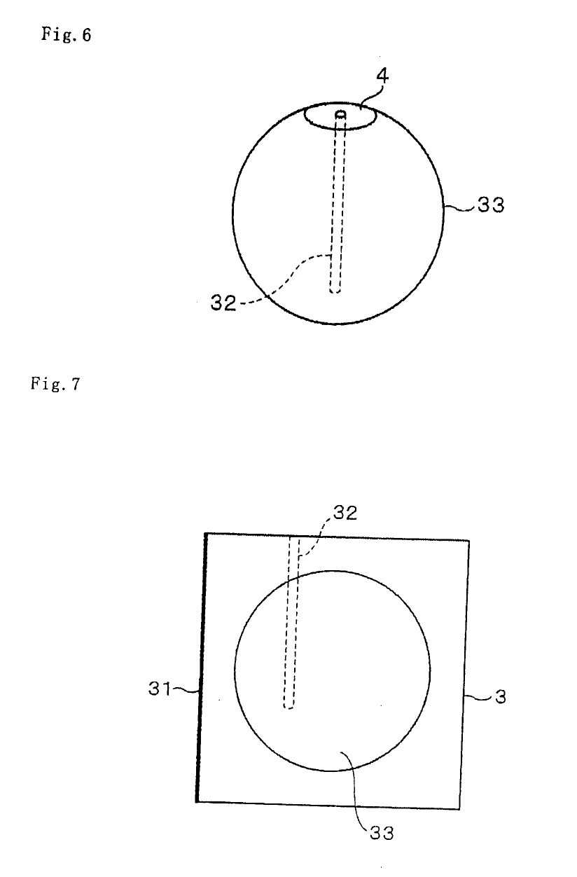

As to the above, in the present invention, after forming the above-described spherical crystal blank 33 provided with the reference hole for Z axis 32, for instance as shown in FIG. 6, a portion of the spherical crystal blank 33 may be cut out in a manner to leave a plane orthogonal to the reference hole for Z axis 32. When conducting in this way, since the plane formed by this cut-out becomes a reference plane 4 corresponding to a plane (XY plane) orthogonal to the Z axis of the quartz crystal blank 2, the piezoelectric resonator 33 may be attached to the substrate 34 in reference to the reference plane 4, or the IDT electrode 35 may be installed on the surface of the piezoelectric resonator 33.

Furthermore, the reference hole for Z axis 32 may be provided not in the region near the central of the spherical crystal blank 33, but at a position toward more peripheral side from the center as shown in FIG. 7. Still further, in the present invention, a polyhedron is cut out, which has a side extending along any of the X axis direction (or the Y axis direction) from the quartz crystal blank 2, instead of the Z axis, and the reference hole for Z axis 32 may be formed in the polyhedron so as to be orthogonal to the X axis (or Y axis), in reference to the X axis direction (or Y axis direction) indicated by the side.

Furthermore, a reference hole for crystal of the present invention may be a reference hole for X axis extending along the X axis direction of a crystal, or may be a reference hole for Y axis extending along the Y axis direction of the crystal, other than the reference hole for Z axis 32. When a spherical SAW device is manufactured, since it is sufficient to install the IDT electrode 35 in parallel to the X axis direction, it is possible to install the IDT electrode 35 with high positional accuracy even when the reference hole for X axis or reference hole for the Y axis is used as a reference.

In addition, when a spherical crystal blank is formed from a polyhedron, the reference hole for Z axis (reference hole for X axis or reference hole for Y axis) is sometimes out of sight. In order to prevent this, a plurality of reference holes for Z axis (the reference holes for X axis or the reference holes for Y axis) may be formed, or a combination of any two or more of the reference hole for Z axis, the reference hole for X axis and the reference hole for Y axis may be formed. When two or more of the reference holes for crystal axis are formed, their respective lengths may be the same or may be different from each other.

What is claimed is:

1. A method of manufacturing a spherical or hemispherical crystal blank provided with crystal axes including a Z axis, and X and Y axes orthogonal to the Z axis, comprising the steps of:
cutting out a polyhedron, having a side extending in any one of crystal axis directions among said Z, X, and Y axis directions, and being of a size including the spherical or hemispherical crystal blank to be manufactured;
forming a reference hole for crystal axis extending along said crystal axis direction in said polyhedron, in reference to the one side of said polyhedron extending in the crystal axis direction; and
forming said polyhedron into a spherical or a hemispherical shape so as to include the whole or a portion of said reference hole for crystal axis.

2. The method of manufacturing the spherical or the hemispherical crystal blank according to claim 1, wherein said spherical or hemispherical crystal blank is a piezoelectric resonator.

3. The method of manufacturing the spherical or the hemispherical crystal blank according to claim 1, wherein said spherical or hemispherical crystal blank is a spherical or a hemispherical lens.

4. The method of manufacturing the spherical or the hemispherical crystal blank according to claim 1, wherein said crystal blank is formed of any one of quartz, lithium niobate, and lithium tantalate.

5. The method of manufacturing the spherical or the hemispherical crystal blank according to claims 1, wherein a hole diameter of said reference hole for crystal axis has a size of 0.1% to 5% with respect to the diameter of the spherical or the hemispherical crystal blank.

6. A method of manufacturing a spherical SAW device, comprising a step of:
installing an IDT electrode to the spherical crystal blank manufactured by the method according to claim 1 so that their electrode fingers are arranged along said X axis in reference to said reference hole for crystal axis.
